(19) United States
(12) Patent Application Publication
(10) Pub. No.: US 2026/0053161 A1
(43) Pub. Date: Feb. 26, 2026

(54) METHOD FOR FRACTIONATED EXTRACTION OF WOODY EDIBLE OIL WITH SUPERCRITICAL CARBON DIOXIDE

(71) Applicant: ZHEJIANG ACADEMY OF FORESTRY, Hangzhou (CN)

(72) Inventors: Yanbin WANG, Hangzhou (CN); Yuchuan QIN, Hangzhou (CN); Liling WANG, Hangzhou (CN); Liang HE, Hangzhou (CN)

(73) Assignee: ZHEJIANG ACADEMY OF FORESTRY, Hangzhou (CN)

(21) Appl. No.: 19/026,391

(22) Filed: Jan. 17, 2025

(30) Foreign Application Priority Data
Aug. 26, 2024 (CN) 202411174244.1

(51) Int. Cl. A23D 9/04; B01D 11/02

(52) U.S. Cl. CPC A23D 9/04; B01D 11/0203; B01D 11/0284; A23V 2200/30; A23V 2300/10; A23V 2300/14; A23V 2300/18; A23V 2300/31; A23V 2300/38; A23V 2300/44; A23V 2300/50

(57) ABSTRACT

A method for fractionated extraction of a woody edible oil with supercritical carbon dioxide is provided. In the method, with a Camellia oleifera Abel seed and a Torreya grandis seed as raw materials, a process for supercritical carbon dioxide extraction of an oil is explored to obtain eco-friendly, safe, and nutritious Camellia oleifera Abel and Torreya grandis seed oil production technologies without chemical refining. The method adopts a fractionated extraction mode where water and free fatty acids are first removed with low-pressure supercritical carbon dioxide and then an oil (triglycerides) is extracted through high-pressure extraction. A product of the method can be marketed without refining. According to different characteristics of oils, the two methods of low-temperature vacuum removal and freeze-drying removal are adopted, which both can meet the target requirements.

### CROSS REFERENCE TO THE RELATED APPLICATIONS

This application is based upon and claims priority to Chinese Patent Application No. 202411174244.1, filed on Aug. 26, 2024, the entire contents of which are incorporated herein by reference.

### TECHNICAL FIELD

The present disclosure relates to a method for fractionated extraction of a woody edible oil with supercritical carbon dioxide, which includes methods for fractionated extraction of a Camellia oleifera Abel seed oil and a Torreya grandis seed oil.

### BACKGROUND

Camellia oleifera Abel is an oil crop of the Camellia L. genus in the Theaceae family. The fruits of Camellia oleifera Abel are rich in oil. Camellia oleifera Abel seed oil is a high-grade, woody, edible oil unique to China. Camellia oleifera Abel seed oil is as famous as palm oil, olive oil, and coconut oil, and these four are known as the four major woody edible oils. Camellia oleifera Abel seed oil is rich in nutrients and has strong health care and medicine values. It is recorded in the “Compendium of Materia Medica” that Camellia oleifera Abel seed oil has the functions of clearing heat and detoxifying, benefiting the stomach and intestines, brightening the eyes, etc. The long-term consumption of Camellia oleifera Abel seed oil can enhance the vascular elasticity, delay the atherosclerosis, and improve the immunity of the human body. Camellia oleifera Abel seed oil is also known as the “oriental olive oil.”

Camellia oleifera Abel seed oil has high nutritional values and special health care functions. Thus, Camellia oleifera Abel seed oil occupies a special position in woody oils. In addition to unsaturated fatty acids (90% or more), Camellia oleifera Abel seed oil is rich in active ingredients such as camellin, tea polyphenols, saponins, tannins, squalene, and flavone. Camellia oleifera Abel seed oil has been heavily promoted by the Food and Agriculture Organization as a healthy, high-grade, edible vegetable oil. Camellia oleifera Abel seed oil is one of the most popular research objects in the food industry of China and is also a woody oil with a promising development prospect. Therefore, how to utilize and develop Camellia oleifera Abel seed oil to serve human health is an important topic for research in the future.

Torreya grandis seeds, also known as Chinese torreya nuts, are a unique medicinal and edible nut in China. Torreya grandis seeds are fruits of Torreya grandis of the Taxaceae family and are mainly produced in the Kuaiji Mountain of Zhejiang Province. Torreya grandis is the main nut cultivar in Zhejiang Province and has also been cultivated in regions such as Anhui Province, Guizhou Province, and Yunnan Province in recent years. Torreya grandis seeds have an oil content of 42% to 61% and exhibit high edible nutritional values. Torreya grandis seeds are rich in proteins and various trace elements and also include a large number of active ingredients such as polyphenols, biflavones, lignans, and terpenes. Torreya grandis seeds are the first batch of food approved by the Ministry of Public Health as a medicinal and edible food. It is recorded in the Chinese medical classics such as Sheng Nong's herbal classic, Compendium of Materia Medica, and Mingyi Bielu that Torreya grandis seeds are “sweet, insipid, astringent, and non-toxic and can kill parasites, prevent the hair from falling,” “allow rapid digestion, strengthen the bones and muscles, regulate the nutrient and defense, improve eyesight and reduce body weight, improve the appetite,” “can treat cough and gonorrhea, and replenish the yangqi.” Torreya grandis seeds are listed by the Chinese Pharmacopoeia (2020 edition) as a traditional Chinese medicine for killing parasites and removing food stagnancy, nourishing lungs to arrest cough, and moistening dryness to relax bowels.

Camellia oleifera Abel seed oil and Torreya grandis seed oil are high-end, woody, edible oils with Chinese characteristics, which have abundant nutrients and high prices. However, the existing processing methods are still relatively backward. Currently, the main extraction methods include pressing, solvent extraction, and aqueous enzymatic extraction, supercritical extraction, and subcritical extraction that are applied less commonly. Due to high treatment temperatures, the pressing method will lead to the increase of some harmful substances such as benzo (a) pyrene and trans-fatty acids. The solvent extraction method and the subcritical method will lead to problems such as solvent residue in refined oil.

Supercritical fluid extraction (SFE) is an efficient and clean extraction and separation technology. The SFE was first developed in the 1980s and has been widely used in fields such as food, medicine, chemical industry, petroleum, and environmental protection. At present, carbon dioxide is a medium most widely used in the supercritical fluid technology. The supercritical fluid technology makes CO₂ in a critical state between a gas and a liquid through pressurizing and heating (critical point: 7.38 MPa, 31.05° C.), such that CO₂ has the dual characteristics of a gas and a liquid. Supercritical CO₂ has a similar viscosity to CO₂ gas, a similar density to CO₂ liquid, and a much larger diffusion coefficient than CO₂ liquid. Supercritical carbon dioxide has a low polarity. By changing the pressure and temperature conditions, supercritical carbon dioxide can achieve the selective extraction and separation of some substances. In particular, supercritical carbon dioxide has great advantages in the extraction of low-polarity substances. In recent years, supercritical carbon dioxide has been widely used in the food and health care product industries for many bioactive compounds, such as caffeine, β-carotene, lecithin, fish oil, high-end edible oil, and food flavor ingredients.

The supercritical technology has been used in the preparation of edible oil for a long time. Although it is mainly used as an extraction technology with a high extraction rate, edible oil prepared by the supercritical technology needs to be refined to meet the consumption requirements of the national standards. The reason for that is the edible oil prepared under this circumstance would undergo high-temperature, acid, and alkali treatments and exhibits a similar quality compared with oil products prepared by solvent extraction and high-temperature pressing but has a relatively high cost. Therefore, in addition to advertising effects, there are few large-scale applications of the supercritical technology on the market. There are the following three reasons why edible oil prepared by the supercritical technology requires chemical refining subsequently: 1. Oil prepared by the supercritical technology has a too-high acid value; 2. Oil prepared by the supercritical technology has a higher moisture content than oil prepared by the pressing method; and 3. There is an emulsification problem in oil prepared by the supercritical technology. The above three reasons also lead to the problem that oil prepared by the traditional supercritical carbon dioxide extraction process cannot be consumed directly and needs to be chemically refined before going on the market.

The present disclosure has explored the process for supercritical carbon dioxide extraction of woody edible oil to obtain an eco-friendly, safe, and nutritious woody edible oil production technology without chemical refining, especially the production technologies for Camellia oleifera Abel seed oil and Torreya grandis seed oil.

### SUMMARY

An objective of the present disclosure is to overcome the above-mentioned deficiencies in the prior art and provide a method for fractionated extraction of a woody edible oil with supercritical carbon dioxide. Using fractionated extraction technology, the edible oil after supercritical extraction can be directly marketed without refining.

In order to solve the above problems, the present disclosure adopts the following technical solutions: The present disclosure provides a method for fractionated extraction of a woody edible oil with supercritical carbon dioxide is provided, where the method adopts a Camellia oleifera Abel seed as a raw material, and includes the following steps:
(1) oven-drying the raw material at 80° C. to 100° C. until a moisture content is 2% to 5%;
(2) shelling the raw material, and crushing to a particle size of 50 mesh;
(3) adding the raw material to a supercritical carbon dioxide extraction device, setting a pressure of a separation reactor I to 10 MPa, a pressure of a separation reactor II to 6 MPa, a pressure of an extraction reactor to 12 MPa, and a temperature of the extraction reactor to 40° C. to 50° C., and conducting extraction for 1.5 h; and collecting an isolate separately;
(4) changing the pressure of the extraction reactor to 18 MPa, conducting extraction for 1.0 h, and collecting an isolate separately;
(5) changing the pressure of the extraction reactor to 48 MPa, conducting extraction for 4 h, and collecting an isolate separately; and
(6) subjecting an oil extract produced in the separation reactor I in the step (5) to vacuum carbon dioxide removal and water removal for 0.5 h to 1.0 h at 45° C. to 50° C., a stirring speed of 40 r/min to 60 r/min, and a vacuum degree of lower than −98 kPa to obtain a refined Camellia oleifera Abel seed oil.

Preferably, in the step (1), the oven-drying is conducted at 90° C., and the moisture content is 2% to 3%.

Preferably, in the step (3), the extraction is conducted at 45° C.

Preferably, in the step (5), after the extraction is completed, an oil produced in the separation reactor I is discharged when the pressure of the separation reactor I drops to 4 MPa or less.

Further, the prepared refined Camellia oleifera Abel seed oil is light yellow and transparent, has a moisture content of less than 0.1% and an acid value of less than 0.5 mg KOH/g, and can meet the requirements of the national standard GB11765-2018 without refining.

Further, at the high-pressure stage, there is a very small amount of an oil in the separation reactor II, and the oil in the separation reactor II has a higher moisture content than an oil in the separation reactor I and thus is discarded. A separation pressure of the separation reactor I is 10 MPa. The oil in the separation reactor I is not released off at any time, but is discharged when the pressure of the separation reactor I drops to 4 MPa or less at the end of extraction in the separation reactor I, which can avoid the problem that the oil is mixed with a trace amount of water under a high pressure to cause emulsification of the oil.

The present disclosure also provides a method for fractionated extraction of a woody edible oil with supercritical carbon dioxide, where the method adopts a Torreya grandis seed as a raw material, and includes the following steps:
(1) subjecting the raw material to husking and then vacuum oven-drying at 50° C. to 80° C. until a moisture content is 2% to 5%;
(2) shelling the raw material, removing an inner seed coat with an inner seed coat removal rate of 80% to 95%, and crushing to a particle size of 50 mesh;
(3) adding the raw material to a supercritical carbon dioxide extraction device, setting a pressure of a separation reactor I to 8 MPa, a pressure of a separation reactor II to 5 MPa, a pressure of an extraction reactor to 8 MPa, and a temperature of the extraction reactor to 40° C. to 50° C., and maintaining extraction process for 1.0 h; and collecting an isolate separately;
(4) changing the pressure of the extraction reactor to 16 MPa to 18 MPa, and maintaining extraction process for 1.0 h, where the pressure of the separation reactor I is 10 MPa and the pressure of the separation reactor II is 6 MPa; and collecting an isolate separately;
(5) changing the pressure of the extraction reactor to 45 MPa, and conducting extraction for 4 h, where the pressure of the separation reactor I is 10 MPa and the pressure of the separation reactor II is 6 MPa; and collecting an isolate separately;
(6) injecting an oil extract produced in the separation reactor I in the step (5) into a low-temperature chamber at −100° C. to produce 0.1 mm to 2 mm solid oil droplets, and freezing for 1 h; and
(7) transferring the frozen Torreya grandis seed oil droplets obtained in the step (6) to a continuous freeze dryer, and conducting water removal and carbon dioxide removal for 1.5 h to 3.0 h at −55° C. and a vacuum degree of −99.5 kPa to obtain a refined Torreya grandis seed oil.

Preferably, in the step (1), the vacuum oven-drying is conducted at 60° C. and a vacuum degree of −95 kPa until the moisture content is 2% to 3%.

Preferably, in the step (2), the inner seed coat removal rate is 90%.

Preferably, in the step (3), the extraction is conducted at 42° C.

Preferably, in the step (5), after the extraction is completed, an oil produced in the separation reactor I is discharged when the pressure of the separation reactor I drops down to 4 MPa or less.

Further, the prepared refined Torreya grandis seed oil can meet the requirements of the national standard GB11765-2018 without refining.

Compared with the prior art, the present disclosure has the following advantages and effects: The present disclosure adopts a fractionated extraction mode where water and free fatty acids are first removed with low-pressure supercritical carbon dioxide and then an oil (triglycerides) is extracted through high-pressure extraction. A product of the method of the present disclosure can be marketed without refining.

According to different characteristics of oils, the present disclosure adopts the two methods of low-temperature vacuum removal and freeze-drying removal, which both can meet the target requirements.

### BRIEF DESCRIPTION OF THE DRAWINGS

FIG. 1 is a flow chart of the method of the present disclosure;

FIG. 2 shows the influence of a drying temperature on total polyphenol and vitamin E contents in an embodiment of the present disclosure;

FIG. 3 shows the influence of a drying temperature on a peroxide value in an embodiment of the present disclosure;

FIG. 4 shows the influence of a drying temperature on benzo (a) pyrene and trans-fatty acids in an embodiment of the present disclosure;

FIG. 5 shows the influence of a moisture content on a yield in an embodiment of the present disclosure;

FIG. 6 shows the influence of a moisture content in a raw material on a moisture content in a product in an embodiment of the present disclosure;

FIG. 7 shows the influence of an extraction pressure on a yield in an embodiment of the present disclosure;

FIG. 8 shows the influence of an extraction temperature on a yield in an embodiment of the present disclosure;

FIG. 9 shows the influence of a temperature on an acid value of a Camellia oleifera Abel seed oil prepared through supercritical extraction in an embodiment of the present disclosure;

FIG. 10 shows the influence of a temperature on a moisture content of a Camellia oleifera Abel seed oil prepared through supercritical extraction in an embodiment of the present disclosure;

FIG. 11 shows the influence of a pressure on an acid value of a Camellia oleifera Abel seed oil prepared through supercritical extraction in an embodiment of the present disclosure; and

FIG. 12 shows the segmented acid value results of Camellia oleifera Abel seed oils prepared through supercritical extraction under different extraction pressures in an embodiment of the present disclosure.

### DETAILED DESCRIPTION OF THE EMBODIMENTS

The present disclosure will be further described in detail below in conjunction with the accompanying drawings and through examples. The following examples are intended to explain the present disclosure, but not limited to the following examples.

### Example 1

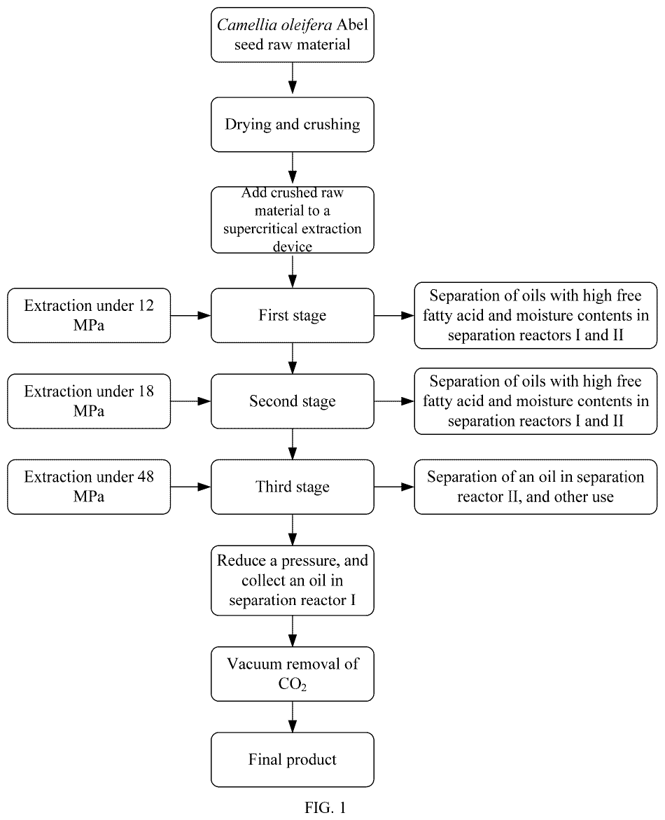

As shown in FIG. 1, in this example, a method for fractionated extraction of a woody edible oil with supercritical carbon dioxide was provided. The method adopted a Camellia oleifera Abel seed as a raw material, and included the following steps:
(1) The raw material was oven-dried at 80° C. to 100° C. until a moisture content was 2% to 5%. Preferably, the oven-drying was conducted at 90° C., and the moisture content was 2% to 3%.
(2) The raw material was uncoated and then crushed to a particle size of 50 mesh.
(3) The raw material was added to a supercritical carbon dioxide extraction device. A pressure of a separation reactor I was set to 10 MPa, a pressure of a separation reactor II was set to 6 MPa, a pressure of an extraction reactor was set to 12 MPa, and a temperature of the extraction reactor was set to 40° C. to 50° C. Extraction was conducted for 1.5 h. An isolate was collected separately. Preferably, the extraction was conducted at 45° C.
(4) The pressure of the extraction reactor was changed to 18 MPa, extraction was conducted for 1.0 h, and an isolate was collected separately.
(5) The pressure of the extraction reactor was changed to 48 MPa, extraction was conducted for 4 h, and an isolate was collected separately. After the extraction was completed, an oil produced in the separation reactor I was discharged when the pressure of the separation reactor I dropped to 4 MPa or less.
(6) An oil extract produced in the separation reactor I in the step (5) was subjected to vacuum carbon dioxide removal and water removal for 0.5 h to 1.0 h at 45° C. to 50° C., a stirring speed of 40 r/min to 60 r/min, and a vacuum degree of lower than −98 kPa to obtain a refined Camellia oleifera Abel seed oil.

### Example 2

In this example, a method for fractionated extraction of a woody edible oil with supercritical carbon dioxide was provided. The method adopted a Torreya grandis seed as a raw material, and included the following steps:
(1) The raw material was subjected to husking and then vacuum oven-drying at 50° C. to 80° C. until a moisture content was 2% to 5%. Preferably, the oven-drying was conducted at 60° C. and a vacuum degree of −95 kPa until the moisture content was 2% to 3%.
(2) The raw material was shelled, an inner seed coat was removed with an inner seed coat removal rate of 80% to 95%, and crushing was conducted to a particle size of 50 mesh. Preferably, the inner seed coat removal rate was 90%.
(3) The raw material was added to a supercritical carbon dioxide extraction device. A pressure of a separation reactor I was set to 8 MPa, a pressure of a separation reactor II was set to 5 MPa, a pressure of an extraction reactor was set to 8 MPa, and a temperature of the extraction reactor was set to 40° C. to 50° C. Extraction was conducted for 1.0 h. An isolate was collected separately. Preferably, the extraction was conducted at 42° C.
(4) The pressure of the extraction reactor was changed to 16 MPa to 18 MPa, and extraction was conducted for 1.0 h, where the pressure of the separation reactor I was 10 MPa and the pressure of the separation reactor II was 6 MPa. An isolate was collected separately.
(5) The pressure of the extraction reactor was changed to 45 MPa, and extraction was conducted for 4 h, where the pressure of the separation reactor I was 10 MPa and the pressure of the separation reactor II was 6 MPa. An isolate was collected separately. Preferably, after the extraction was completed, an oil produced in the separation reactor I was discharged when the pressure of the separation reactor I dropped to 4 MPa or less.
(6) An oil extract produced in the separation reactor I in the step (5) was injected into a low-temperature chamber at −100° C. to produce 0.1 mm to 2 mm solid oil droplets, and the solid oil droplets were frozen for 1 h.
(7) The frozen Torreya grandis seed oil droplets obtained in the step (6) were transferred to a continuous freeze dryer, and water removal and carbon dioxide removal were conducted for 1.5 h to 3.0 h at −55° C. and a vacuum degree of −99.5 kPa to obtain a refined Torreya grandis seed oil.

### Example 3

The method for fractionated extraction of a woody edible oil with supercritical carbon dioxide provided in the present disclosure not only can be used for Camellia oleifera Abel seeds and Torreya grandis seeds, but also can be used for woody raw materials such as walnuts, peonies, pine nuts, and hickory nuts. However, different raw materials require slightly-different conditions due to different characteristics.

In this example, a method for fractionated extraction of a woody edible oil with supercritical carbon dioxide was provided. The method adopted a walnut as a raw material, and included the following steps:
(1) The raw material was subjected to husking and then vacuum oven-drying at 50° C. to 80° C. until a moisture content was 2% to 5%. Preferably, the oven-drying was conducted at 50° C. and a vacuum degree of −95 kPa until the moisture content was 2% to 3%.
(2) The raw material was uncoated, diaphragma juglandis fructus was removed, and then crushing was conducted to a particle size of 50 mesh.
(3) The raw material was added to a supercritical carbon dioxide extraction device. A pressure of a separation reactor I was set to 8 MPa, a pressure of a separation reactor II was set to 5 MPa, a pressure of an extraction reactor was set to 8 MPa, and a temperature of the extraction reactor was set to 40° C. to 50° C. Extraction was conducted for 1.0 h. An isolate was collected separately. Preferably, the extraction was conducted at 42° C.
(4) The pressure of the extraction reactor was changed to 16 MPa to 18 MPa, and extraction was conducted for 1.0 h, where the pressure of the separation reactor I was 10 MPa and the pressure of the separation reactor II was 6 MPa. An isolate was collected separately.
(5) The pressure of the extraction reactor was changed to 40 MPa, and extraction was conducted for 4 h, where the pressure of the separation reactor I was 10 MPa and the pressure of the separation reactor II was 6 MPa. An isolate was collected separately. After the extraction was completed, an oil produced in the separation reactor I was discharged when the pressure of the separation reactor I dropped to 4 MPa or less.
(6) An oil extract produced in the separation reactor I in the step (5) was subjected to vacuum carbon dioxide removal and water removal for 1 h at 45° C., a stirring speed of 40 r/min to 60 r/min, and a vacuum degree of −99.5 kPa to obtain a refined walnut oil.

The selection of test parameters in the above examples is described below.

(1) a Camellia oleifera Abel Seed Raw Material is Dried at 80° C. To 100° C., and a Torreya grandis Seed Raw Material is Vacuum-Dried at 50° C. To 80° C.

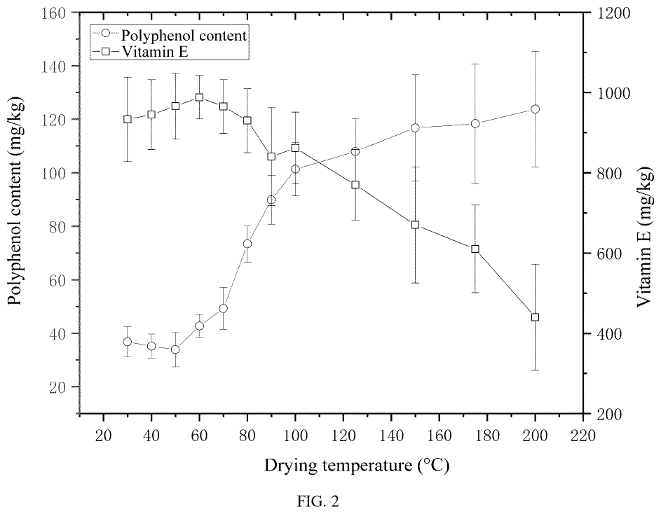

Studies have shown (FIG. 2 to FIG. 4) that the increase in a drying temperature will lead to the oxidation of vitamins and the increase in peroxide values and harmful substances such as benzo (a) pyrene of a raw material and a product. Studies also have shown that, when a drying temperature increases in a specified range, a polyphenol content in a raw material will increase, which is attributed to the fact that monomeric polyphenols will be released from some polyphenols binding to sugars and proteins at high temperatures. The above behavior also greatly improves the oxidation resistance of a product. The selection of a drying temperature is a result of the balance among the increase of a polyphenol content, the decrease of a vitamin content, the increase of a peroxide value, and the increase of contents of harmful substances such as benzo (a) pyrene. In the present disclosure, a drying temperature of 80° C. to 100° C. is selected for Camellia oleifera Abel seeds.

A drying temperature for Torreya grandis seeds is different from the drying temperature for Camellia oleifera Abel seeds. In particular, Torreya grandis seeds need to be dried under vacuum, which is not necessary for Camellia oleifera Abel seeds. This is attributed to the following reason: Among oils in Camellia oleifera Abel seeds, 80% are monounsaturated fatty acids, 10% are polyunsaturated fatty acids (which are mainly dienoic acids), and 10% are saturated fatty acids. Among oils in Torreya grandis seeds, only 30% are monounsaturated fatty acids and 55% are polyunsaturated fatty acids (40% of which are dienoic acids and 15% of which are trienoic acids). Studies have shown that an oxidation rate ratio of monounsaturated fatty acids, diunsaturated fatty acids, and triunsaturated fatty acids is 1:10.3:21.6. The inventors have also found through practice that an inappropriate drying manner can cause a peroxide value of a Torreya grandis seed oil to increase by more than 200%. Therefore, in the present disclosure, a drying temperature of 50° C. to 80° C. is selected for Torreya grandis seeds.

(2) A raw material is dried to a moisture content of 2% to 5%.

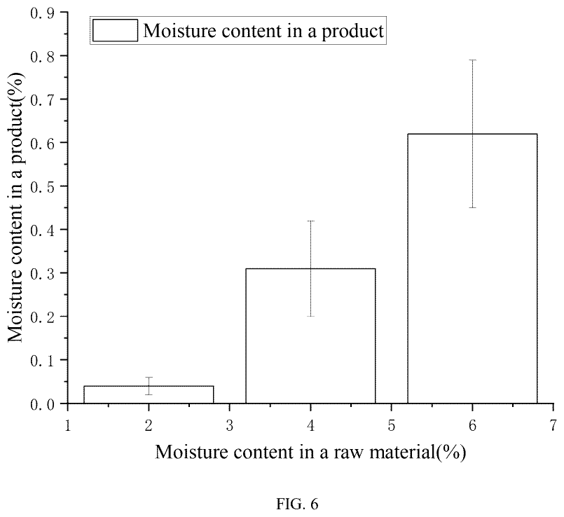

The inventors have found through research that a moisture content of a raw material is positively correlated with a moisture content of a product (FIG. 6), and is also closely related to an extraction yield of free fatty acids during a supercritical carbon dioxide extraction process. A too-high moisture content in a raw material is not conducive to storage, and will also cause emulsification during the collection of a raw material, which affects the subsequent dewatering. Especially for raw materials with saponins, a too-high moisture content will make saponins easily dissolved, which aggravates the occurrence of emulsification. However, a specified proportion of moisture is conducive to the removal of free fatty acids. Therefore, a moisture content of a raw material is not the lower the better.

### (3) Particle Size for Crushing

According to a practical situation, a too-small particle size should be avoided, which may cause a raw material to escape from the separation reactor into a separation reactor and a pipeline, and a too-large particle size should also be avoided, which may affect a leaching and extraction effect of carbon dioxide.

### (4) Fractionated Extraction

According to the research and practice of the inventors, water and free fatty acids are extracted first under the conditions of a low pressure and a specified moisture content and temperature, then an oil product produced subsequently under the conditions of a high pressure and a specified temperature has low moisture and free fatty acid contents. Because different raw materials have different characteristics, conditions of fractionated extraction for different raw materials are slightly different.

(5) an Inner Seed Coat Removal Rate for a Torreya grandis Raw Material is 80% to 95%.

The inner seed coats of Torreya grandis are rich in polyphenols. When a specified amount of black inner seed coats of Torreya grandis (according to a drying situation, some inner seed coats are brown or black) is retained, the polyphenols will be extracted together with an oil during an extraction process to improve the oxidation resistance of a product. However, the inner seed coats also include a large amount of quinones and melanin that are easily oxidized and discolored. Thus, if a too-large amount of inner seed coats is retained, a product will have an undesirable brown-red color, and is very prone to photooxidation.

(6) at a Third Stage of Fractionated Extraction, after a Pressure of a Separation Reactor Drops to 4 MPa, an Oil Extracted is Released.

During supercritical carbon dioxide extraction, when an oil is released from a separation reactor under a high pressure and especially when the oil includes a specified amount of moisture, emulsification easily occurs under high pressure impact. An emulsified oil seriously affects the subsequent dewatering. Therefore, the oil needs to be released after a pressure of the separation reactor is reduced. During a continuous extraction process, the pressure of the separation reactor cannot be reduced to an atmospheric pressure. According to the research results of the inventors, it is not prone to emulsification when the pressure is 4 MPa or less.

(7) Carbon Dioxide and Water Need to be Removed from a Woody Edible Oil Prepared by Supercritical Carbon Dioxide Extraction Using a Vacuum or Low-Temperature Freeze-Drying Method At a Specified Temperature.

Moisture in an oil is one of the important causes of hydrolytic deterioration of the oil, and thus must be removed. During a supercritical extraction process, due to the similar polarities of an oil and carbon dioxide, even at atmospheric pressure and room temperature, some carbon dioxide remains in the oil and cannot be removed. A trace amount of carbon dioxide is dissolved in water to produce carbonic acid, and a slightly-acidic environment aggravates the hydrolysis of triglycerides, which is also the reason why some researchers have found that an oil prepared by supercritical carbon dioxide cannot be stored for a long time.

In addition, an oil prepared by the conventional supercritical carbon dioxide extraction has a higher acid value than an oil prepared by the pressing method, which does not indicate a higher free fatty acid content. A detection principle of an acid value is acid-base neutralization. Carbon dioxide in an oil will also consume a potassium hydroxide reagent, such that a detected acid value is higher than an actual free fatty acid content. An acidic part of an oil produced at a low-pressure stage of supercritical extraction is mainly composed of free fatty acids and involves less carbon dioxide, and an acid value remains basically unchanged before and after a vacuum treatment. An acidic part of an oil produced at a high-pressure stage is mainly composed of carbon dioxide and involves few free fatty acids, and after a vacuum treatment, the carbon dioxide is removed and an acid value decreases greatly.

The influence of test parameters is investigated below.

### Research on Drying Temperatures

Polyphenols exert many functions in edible oils, and especially play a prominent antioxidant role in oils. The more the natural antioxidant active ingredients such as polyphenols and vitamin E, the higher the oxidation resistance of an oil itself. Thus, a product can protect itself without an exogenous antioxidant (such as butylated hydroxytoluene (BHT)), and can play a protective role such as oxidation resistance and free radical resistance in the human body after being consumed.

Polyphenols in Camellia oleifera Abel seeds mostly exist in a binding state, where polyphenol monomers bind to proteins, sugars, etc., resulting in a high aqueous solubility and a low oil solubility. A high-temperature treatment can destroy the binding of polyphenols to proteins and sugars to produce polyphenol monomers, which can increase the fat solubility. However, a high temperature will lead to the aggravation of oxidation of oils and the production of harmful substances such as trans-fatty acids and benzo (a) pyrene. Therefore, the selection of an appropriate temperature is very important, which can increase a content of polyphenols in a raw material, but does not cause the production of harmful substances such as trans-fatty acids and polycyclic aromatic hydrocarbons.

With gallic acid as a standard sample, contents of total polyphenols at different drying temperatures are detected. A sample is dried to a moisture content of 3%.

It can be clearly seen from FIG. 2 that, with the increase of a drying temperature, a content of free polyphenols in Camellia oleifera Abel seeds increases, and especially in a drying temperature range of 60° C. to 140° C., the content of free polyphenols in Camellia oleifera Abel seeds increases most significantly. With the climb of a drying temperature, a content of vitamin E tends to decrease overall, where although the content of vitamin E increases slightly at an early stage, it is not significant.

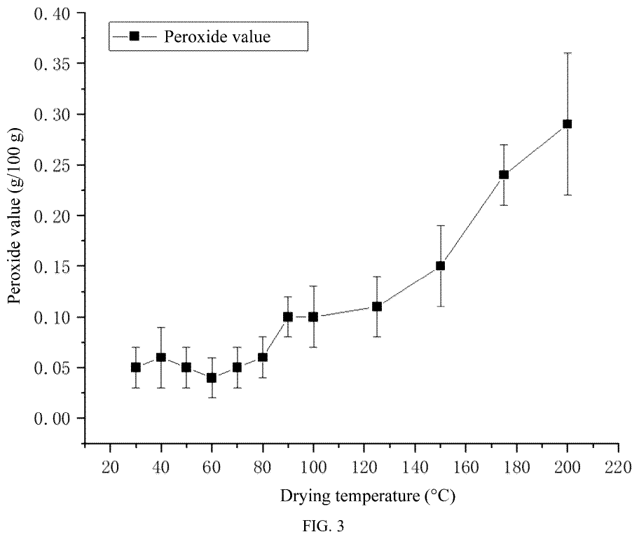

With the increase of a temperature and the extension of a time, the oxidation of an oil becomes more and more severe. It can be seen from FIG. 3 that, especially after a drying temperature exceeds 100° C., a peroxide value increases very significantly. Although the vacuum drying can significantly reduce a peroxide value of a Camellia oleifera Abel seed raw material, it is difficult to implement the vacuum drying in production, which will increase the energy consumption and cost.

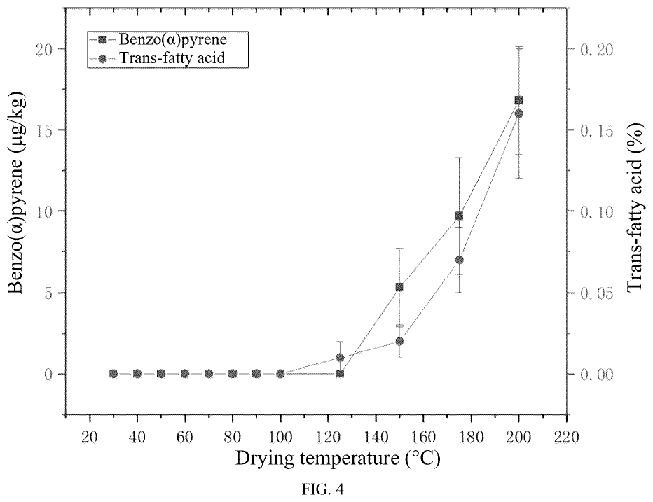

It can be seen from FIG. 4 that, with the increase of a drying temperature, especially when the drying temperature is higher than or equal to 125° C., the polycyclic aromatic hydrocarbon carcinogen of benzo (a) pyrene and the trans-fatty acids are detected, and contents of these two hazards increase with the increase of the drying temperature.

Research on Supercritical Extraction Parameters (with a Maximum Yield as a Goal)

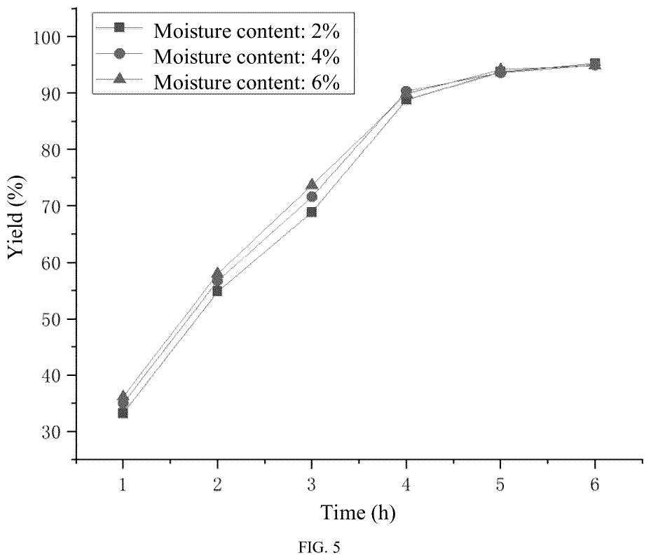

A moisture content of a raw material has a slight impact on an extraction yield, but exhibit a little impact on a yield of a final product (FIG. 5). A high moisture content of a raw material will inevitably increase a moisture content of a product. It can be seen from FIG. 6 that a high moisture content in a raw material leads to a high moisture content in a product, and there are significant differences among different moisture contents. When a moisture content in a raw material is 6%, a moisture content in a product reaches 0.62%, which has far exceeded the requirement of GB/T11765-2018 (less than or equal to 0.2%). However, when a moisture content in a raw material is 2%, a moisture content in a product is 0.04%, which is lower than the requirement of the above national standard. However, it is difficult to dry a material to a moisture content of 2%, and the problems such as energy consumption and raw material oxidation all are factors restricting the further drying. In an actual production, a moisture content of 3% is selected as a moisture content to which a raw material is dried.

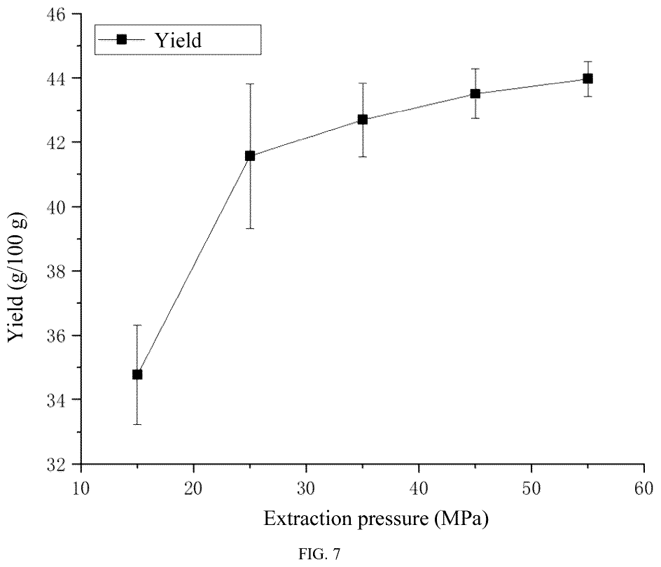

It can be seen from FIG. 7 that, in the conventional pressure range of 15 MPa to 55 MPa, an extraction yield increases with the increase of a pressure, but in a late part of this pressure range, especially in a range of 25 MPa to 55 MPa, the extraction yield does not increase significantly. Under a low pressure, an error between parallel tests is large, indicating that other factors, such as a temperature and a carbon dioxide flow rate, have great impacts.

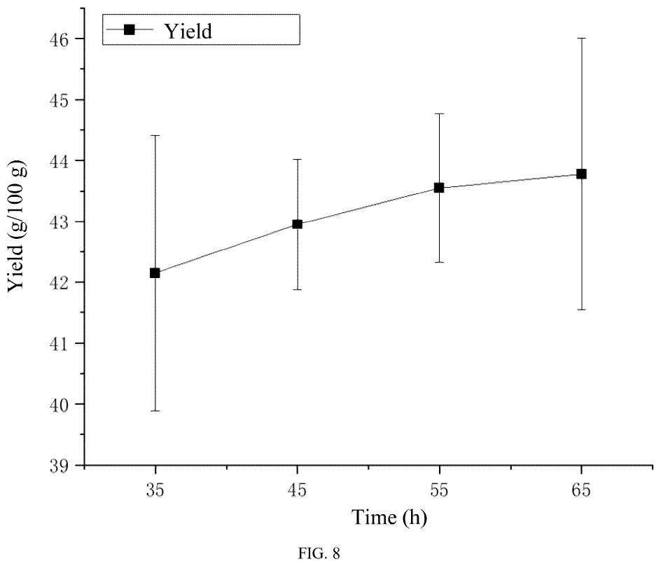

It can be seen from FIG. 8 that an impact of an extraction temperature on a yield is positive, and a yield increases synchronously with the increase of a temperature. However, in a range of 35° C. to 65° C., a change is not significant, and an error is large.

### Results of Response Surface Optimization

According to a single-factor test, a response surface study is conducted after the focus of the three selected factors including pressure, temperature, and time. Table 1 shows the response surface design solutions and results.

TABLE 1
Response surface design solutions and results

| | | A: Pressure | B: Temperature | C: Time | Yield |
|---|---|---|---|---|---|
| Std | Run | MPa | ° C. | Hr | % |
| 2 | 1 | 45 | 32 | 4 | 37.92 |
| 4 | 2 | 45 | 52 | 4 | 43.61 |
| 12 | 3 | 35 | 52 | 6 | 42.14 |
| 10 | 4 | 35 | 52 | 2 | 25.18 |
| 6 | 5 | 45 | 42 | 2 | 27.82 |
| 16 | 6 | 35 | 42 | 4 | 38.17 |
| 17 | 7 | 35 | 42 | 4 | 37.07 |
| 5 | 8 | 25 | 42 | 2 | 15.92 |
| 7 | 9 | 25 | 42 | 6 | 31.29 |
| 8 | 10 | 45 | 42 | 6 | 43.83 |
| 11 | 11 | 35 | 32 | 6 | 36.27 |
| 15 | 12 | 35 | 42 | 4 | 38.00 |
| 9 | 13 | 35 | 32 | 2 | 22.51 |
| 1 | 14 | 25 | 32 | 4 | 31.07 |
| 14 | 15 | 35 | 42 | 4 | 36.82 |
| 13 | 16 | 35 | 42 | 4 | 36.28 |
| 3 | 17 | 25 | 52 | 4 | 26.23 |

### Results of Analysis of Variance of a Model:

According to test results, the analysis of variance of the model is conducted by a Quadratic method. Analysis results are shown in Table 2.

TABLE 2
Results of analysis of variance of the model

| | Sum of | | Mean | | | |
|---|---|---|---|---|---|---|
| Source | Squares | Df | Square | F-value | p-value | |
| Model | 969.26 | 9 | 107.7 | 75.26 | <0.0001 | signif- |
| | | | | | | icant |
| A-Pressure | 296.1 | 1 | 296.1 | 206.91 | <0.0001 | |
| B-Temp | 11.02 | 1 | 11.02 | 7.7 | 0.0275 | |
| C-Time | 482.05 | 1 | 482.05 | 336.85 | <0.0001 | |
| AB | 27.72 | 1 | 27.72 | 19.37 | 0.0032 | |
| AC | 0.1024 | 1 | 0.1024 | 0.0716 | 0.7968 | |
| BC | 2.56 | 1 | 2.56 | 1.79 | 0.2229 | |
| A² | 20.11 | 1 | 20.11 | 14.05 | 0.0072 | |
| B² | 0.5929 | 1 | 0.5929 | 0.4143 | 0.5403 | |
| C² | 121.32 | 1 | 121.32 | 84.77 | <0.0001 | |
| Residual | 10.02 | 7 | 1.43 | | | |
| Lack of Fit | 7.45 | 3 | 2.48 | 3.87 | 0.1119 | not |
| | | | | | | signif- |
| | | | | | | icant |
| Pure Error | 2.57 | 4 | 0.6414 | | | |
| Cor Total | 979.27 | 16 | | | | |

According to the results of analysis of variance, a p value of the model is less than 0.0001, a regression result is significant, and the lack of fit is higher than 0.05 and is not significant, indicating that the model well reflect an actual situation and a regression equation has excellent goodness of fitting.

It can be seen from the results of analysis of variance of the model in Table 2 that, among the three factors, the pressure and the time have an extremely significant impact on the study, and the temperature has a significant impact on the study, and the order of these three factors on an extraction yield rank is as follows: time>pressure>temperature.

According to results of response surface analysis, the following quadratic multiple regression model of an extraction yield (%) with an extraction pressure (A), an extraction temperature (B), and an extraction time (C) is obtained:

$$yeild = - 12.80185 + 1.0004 * A - 0.64879 * B + 12.65675 * C + 0.026325 * AB + 0.008 * AC + 0.04 * BC - 0.021852 * {A}^{2} - 0.003752 * {B}^{2} - 1.34194 * {C}^{2} .$$

Fitting results of the model are shown in Table 3.

TABLE 3
Statistical results of model fitting

| | | | |
|---|---|---|---|
| Std. Dev. | 1.2 | R² | 0.9898 |
| Mean | 33.54 | Adjusted R² | 0.9766 |
| C.V. % | 3.57 | Predicted R² | 0.8742 |
| | | Adeq Precision | 31.1377 |

The adjusted R² of a model equation is 0.9766, indicating excellent model fitting.

### Optimization of a Response Surface Model:

With a maximum yield (100%, 45.01 g/100 g) as an optimization goal, the optimization is conducted with the Design expert software to obtain the optimization results in Table 4.

TABLE 4
Parameter optimization results

| | Pressure | Temperature | Time | Yield | Desir- | |
|---|---|---|---|---|---|---|
| No. | MPa | ° C. | Hr | g/100 g | ability | |
| 1 | 48.044 | 44.446 | 5.4 | 45.677 | 1 | Selected |
| 2 | 47.984 | 43.942 | 5.125 | 45.233 | 1 | |
| 3 | 51.498 | 48.656 | 4.896 | 47.621 | 1 | |
| 4 | 51.192 | 47.468 | 5.967 | 47.378 | 1 | |
| 5 | 47 | 44.222 | 5.444 | 45.44 | 1 | |
| 6 | 50.667 | 43.778 | 4.944 | 45.02 | 1 | |
| 7 | 50.173 | 47.089 | 4.869 | 46.643 | 1 | |
| 8 | 46.168 | 44.952 | 6.123 | 45.15 | 1 | |
| 9 | 42.152 | 51.39 | 5.742 | 46.483 | 1 | |
| 10 | 47.778 | 44.963 | 5.636 | 45.905 | 1 | |
| 11 | 43.731 | 47.323 | 5.523 | 45.885 | 1 | |
| 12 | 47.333 | 50.296 | 4.648 | 47.087 | 1 | |
| 13 | 52.83 | 45.295 | 5.695 | 46.249 | 1 | |
| 14 | 49.776 | 44.333 | 6.16 | 45.228 | 1 | |
| 15 | 52.005 | 51.242 | 5.081 | 49.37 | 1 | |
| 16 | 50.853 | 45.252 | 4.727 | 45.42 | 1 | |
| 17 | 52.921 | 46.6 | 5.041 | 46.709 | 1 | |
| 18 | 52.66 | 45.284 | 5.46 | 46.273 | 1 | |
| 19 | 51.993 | 49.504 | 5.639 | 48.794 | 1 | |
| 20 | 48.503 | 50.58 | 6.207 | 48.304 | 1 | |

The optimization results are as follows: a pressure: 48.0 MPa, a temperature: 44.5° C., and a time: 5.4 h. Three extraction tests are conducted according to the optimization results, with a yield of 44.43±1.12 g/100 g and an extraction rate of 98.71%. For convenient operations, an extraction pressure of 48.0 MPa and an extraction temperature of 45° C. are selected in the present disclosure.

### Research on Acid Value Reduction

According to the relevant national standards, a Camellia oleifera Abel seed oil prepared by supercritical carbon dioxide extraction is analyzed for relevant safety indexes. The Camellia oleifera Abel seed oil prepared by supercritical extraction does not need to be filtered, and is naturally clear and transparent. A pressed oil is turbid and has many granular insoluble substances. Even after the filtration of pressed oil, there will be problems such as benzo (a) pyrene residue, high acid value, and high phospholipid content. Thus, the pressed oil needs to be refined before the consumption. Test results of a crude oil prepared by supercritical extraction are shown in Table 5 below.

TABLE 5
Comparison table between the indexes of Camellia oleifera Abel seed
oil prepared by supercritical extraction and national standard indexes

| | | | National standard | |
|---|---|---|---|---|
| Items | | Results | requirements | Remarks |
| Conventional | Smell | Requirements | There is the | |
| indexes | | to be met | inherent smell and | |
| | | | taste of Camellia | |
| | | | oleifera Abel seed | |
| | | | oil, and there is | |
| | | | no peculiar smell. | |
| | Moisture and volatile | 0.13 | ≤0.20 | |
| | contents, % | | | |
| | Insoluble impurities, % | Not detected | ≤0.20 | |
| | | (<0.01) | | |
| Chemical | Acid value, mg/g KOH | 1.67 | 2.0 | GB/T 11765-2018 |
| indexes | Peroxide value, g/100 g | 0.058 | 0.25 | Camellia oleifera Abel |
| | | | | seed oil: standard for |
| | | | | grade 1 pressed oil |
| | Phospholipids, mg/g | Not detected | — | |
| | | (<1.0) | | |
| Plasticizer, | Dimethyl phthalate (DMP) | Not detected | — | In the “Letter of the |
| mg/kg | | (<0.5) | | Ministry of Public Health |
| | Diethyl phthalate (DEP) | Not detected | — | on Notification of |
| | | (<0.5) | | Maximum Residues of |
| | Diisobutyl phthalate (DIBP) | Not detected | — | Phthalate Substances |
| | | (<0.5) | | in Foods and Food |
| | Di-n-butyl phthalate (DBP) | Not detected | 0.3 | Additives (Supervision |
| | | (<0.1) | | Letter of the General |
| | Bis(2-methoxy)ethyl | Not detected | — | Office of the National |
| | phthalate (DMEP) | (<0.5) | | Health Commission of |
| | Bis(2-ethoxy)methyl | Not detected | — | the People's Republic |
| | phthalate (DEMP) | (<0.5) | | of China [2011] No. 551), |
| | Bis(4-methyl-2-pentyl) | Not detected | — | the Department of Food |
| | phthalate (BMPP) | (<0.5) | | Production Safety |
| | Dipentyl phthalate (DPP) | Not detected | — | Supervision and |
| | | (<0.5) | | Administration, the |
| | Dihexyl phthalate (DHXP) | Not detected | — | State Administration |
| | | (<0.5) | | for Market Regulation |
| | Butyl benzyl phthalate | Not detected | — | [2019] No. 214, it is |
| | (BBP) | (<0.5) | | pointed out that |
| | Bis(butoxy)ethyl | Not detected | — | maximum residues of |
| | phthalate (DBEP) | (<0.5) | | bis(2-ethyl)hexyl |
| | Bis(2-ethyl)hexyl | Not detected | 1.5 | phthalate (DEHP), |
| | phthalate (DEHP) | (<0.5) | | diisononyl phthalate |
| | Diphenyl phthalate (DPhP) | Not detected | — | (DINP), and di-n-butyl |
| | | (<0.5) | | phthalate (DBP) in |
| | Di-n-octyl phthalate (DNOP) | Not detected | — | foods and food additives |
| | | (<0.5) | | are 1.5 mg/kg, 9.0 |
| | Dinonyl phthalate (DNP) | Not detected | 9.0 | mg/kg, and 0.3 mg/kg, |
| | | (<0.5) | | respectively. |
| | Diisononyl phthalate (DINP) | Not detected | 1.5 | |
| | | (<0.5) | | |
| | Dimethyl phthalate (DMP) | Not detected | — | |
| | | (<0.5) | | |
| | Diallyl phthalate (DAP) | Not detected | — | |
| | | (<0.5) | | |
| Fungal toxins | Aflatoxin B1, μg/kg | Not detected | 10.0 | GB2761-2017 Limits of |
| | | (<1.0) | | fungal toxins in food |
| Polycyclic | Benzo(α)pyrene, μg/kg | Not detected | 10.0 | GB2762-2017 Limits of |
| aromatic | | (<0.1) | | contaminants in food |
| hydrocarbons | | | | |

Note:
The bolded items are items that require special attention.

It can be seen from the above table that the Camellia oleifera Abel seed oil prepared by supercritical extraction has excellent safety, and can meet the requirements of national standards once produced. In particular, phospholipids are basically undetectable, which is related to the prominent water solubility of phospholipids. A very low phospholipid content (not detected) also makes the Camellia oleifera Abel seed oil prepared by the supercritical process not require the refining procedure of water washing for colloidal impurity removal.

However, it can also be seen from the table that two problems may encounter as following: 1. A moisture content is high. The high moisture content in the oil will lead to the hydrolysis of triglycerides during a storage process, the increase of an acid value, and the increase of oxidation products. A moisture content of about 0.1% is a relatively-dangerous moisture content level. 2. An acid value is relatively high and is 1.67 mg KOH/g. Although the acid value meets the requirements of the national standards, the acid value is close to 2.0 mg KOH/g required in the new national standard and is higher than 1.0 mg KOH/g required in the old national standard.

Therefore, if the Camellia oleifera Abel seed oil directly prepared by supercritical carbon dioxide needs to be stored and consumed directly without refining, a moisture and acid reduction treatment is further required. The results of the response surface experiment are also analyzed for an acid value, but the model is not significant. An acid value cannot be optimized relevantly by the response surface experiment.

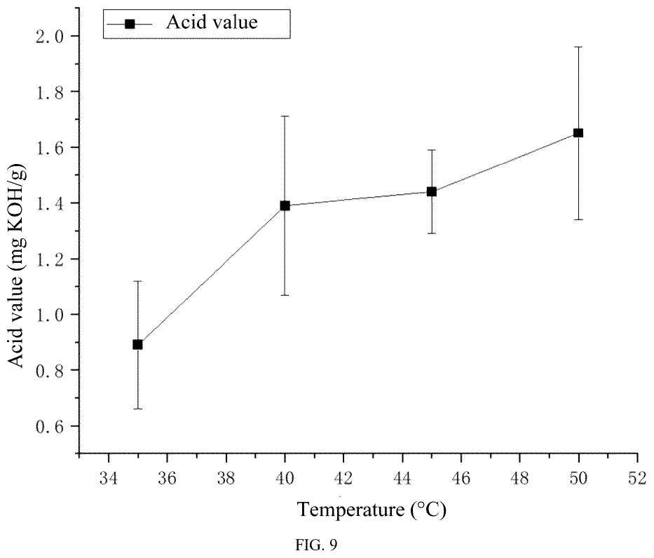

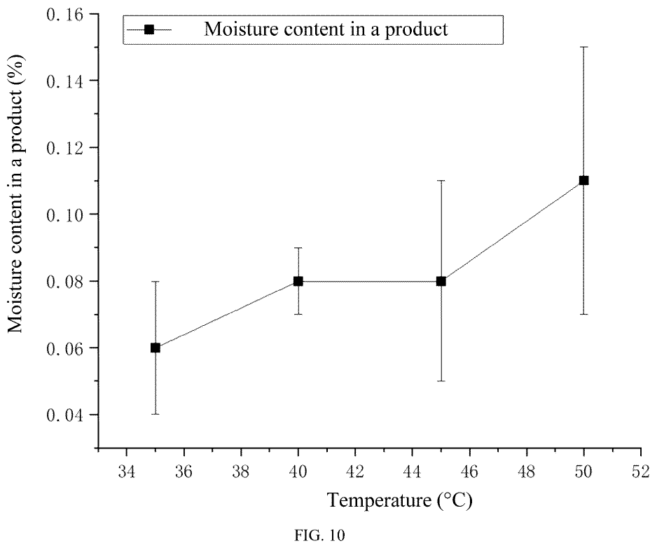

It can be seen from FIG. 9 and FIG. 10 that a temperature has a specified impact on a moisture content and an acid value of the Camellia oleifera Abel seed oil prepared by the supercritical process, but the impact is not significant, and the two indexes increase with the increment of the temperature.

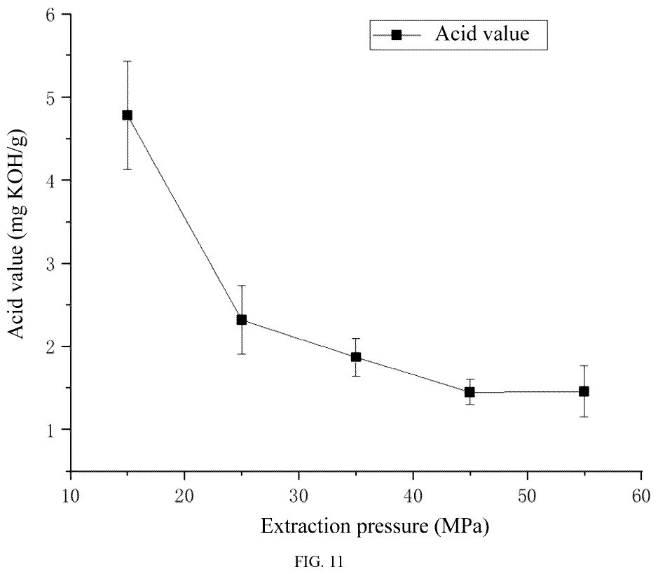

FIG. 11 shows the influence of an extraction pressure on an acid value of Camellia oleifera Abel seed oil prepared through supercritical extraction. It can be observed from this figure that, with the increase of the extraction pressure, the acid value of the Camellia oleifera Abel seed oil prepared through supercritical extraction decreases. The acid value of the Camellia oleifera Abel seed oil reaches a maximum of 4.78 mg KOH/g at a pressure of 15 MPa, and has a minimum of 1.45 mg KOH/g at a pressure of 45 MPa that is close to an acid value at a pressure of 55 MPa.

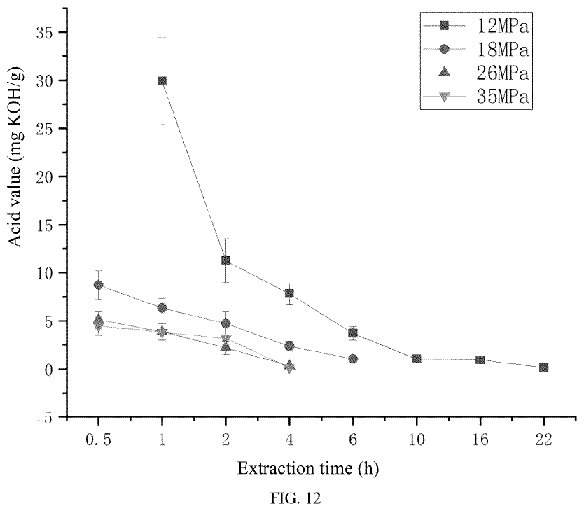

However, at a low pressure, especially at an extraction pressure of 20 MPa or less, an oil yield is extremely low. In order to understand the acid values of oils produced under different pressures in a targeted manner, the segmented collection is conducted to obtain the detailed data related to the pressure and acid value. Specific results are shown in FIG. 12 and Table 6.

TABLE 6
Segmented acid value results of Camellia oleifera
Abel seed oils prepared through supercritical extraction
under different extraction pressures

| Extraction | Acid value (mg KOH/g) | | | |
|---|---|---|---|---|
| time h | 12 MPa | 18 MPa | 26 MPa | 35 MPa |
| 0.5 | — | 8.73 ± 1.49 | 5.12 ± 0.87 | 4.48 ± 0.97 |
| 1 | 29.87 ± 4.52 | 6.33 ± 1.01 | 3.87 ± 0.82 | 3.85 ± 0.92 |
| 2 | 11.25 ± 2.27 | 4.74 ± 1.21 | 2.21 ± 0.7 | 3.2 ± 0.65 |
| 4 | 7.81 ± 1.14 | 2.37 ± 0.52 | 0.32 ± 0.11 | 0.16 ± 0.04 |
| 6 | 3.71 ± 0.72 | 1.05 ± 0.32 | | |
| 10 | 1.04 ± 0.27 | | | |
| 16 | 0.94 ± 0.11 | | | |
| 22 | 0.16 ± 0.07 | | | |

Note:
No sample is collected at 0.5 h under a pressure of 12 MPa.

It can be obviously seen from the data in FIG. 12 and Table 6 that an acid value of an extracted oil decreases over time under a low pressure. At a pressure of 12 MPa, the initial acid value reaches the astounding 29.87 mg KOH/g. With the extension of time, an acid value of the last sample is 0.16 mg KOH/g. There is almost the same effect under the extraction pressures of 18 MPa, 26 MPa, and 35 MPa. Therefore, according to the above research results, the supercritical extraction pressure is improved into a fractionated extraction mode. Fractionated pressures are as follows:
pressures of an extraction reactor: a raw material - - - →12 MPa - - - →18 MPa→48 MPa and
pressures of separation reactors: a pressure of a first-stage separation reactor: 10 MPa, and a pressure of a second-stage separation reactor: 6 MPa.

Masses and qualities of Camellia oleifera Abel seed oils prepared are as follows:

TABLE 7
Results of yields, acid values, and moisture contents
of Camellia oleifera Abel seed oils prepared through
fractionated extraction (separation reactor I)

| | | Average | | Moisture |
|---|---|---|---|---|
| Pressure | Oil mass | yield | Acid value | content |
| MPa | g | % | mg KOH/g | % |
| 12 | 18.14 ± 6.22 | 0.56 | 7.42 ± 4.41 | 6.78 ± 1.69 |
| 18 | 116.04 ± 18.69 | 3.59 | 3.23 ± 1.33 | 0.32 ± 0.10 |
| 48 | 3169.13 ± 24.92 | 93.9 | 0.87 ± 0.26 | 0.06 ± 0.02 |

It can be seen from Table 7 that, during the fractionated extraction of a Camellia oleifera Abel seed oil, at the late high-pressure stage, a yield is 93.90%, and an acid value and a moisture content can well meet the requirements of national standards, and the moisture and free fatty acids are mainly retained in extracts at the low-pressure stages.

The different pressures in the separation reactors have a great impact during the low-pressure stages. At a pressure of 12 MPa, an oil in the separation reactor I has a moisture content of 6.78% and an acid value of 7.42 mg KOH/g, but an oil in the separation reactor II has a moisture content of 39.62±12.14% and an acid value of 66.54±11.08 mg KOH/g, which is discarded. At the high-pressure stage, an oil is mainly separated in the separation reactor I, and there is basically no oil in the separation reactor II.

Influence of a vacuum treatment on an acid value of an oil prepared through supercritical extraction:

In the national standard, an acid value is detected through potassium hydroxide titration, which is based on the principle of acid-base neutralization. In a supercritical extraction process, the extraction is conducted based on the “like dissolves like” principle of non-polar carbon dioxide and low-polarity triglycerides, which will inevitably cause the problem that a small amount of carbon dioxide is dissolved in triglycerides. A Camellia oleifera Abel seed oil prepared through the above supercritical carbon dioxide extraction is vacuum-degassed for 6.0 h at room temperature and a vacuum degree of −98 kPa, and then an acid value fluctuation is recorded. Results are shown in Table 8.

TABLE 8
Changes in acid values of Camellia oleifera
Abel seed oils prepared through fractionated extraction
before and after the vacuum treatment

| | | Acid value (mg KOH/kg) | |
|---|---|---|---|
| Pressure | | Before the | After the |
| MPa | Separation reactor | vacuum treatment | vacuum treatment |
| 12 | Reactor I | 7.42 ± 4.41 | 7.55 ± 2.01 |
| 12 | Reactor II | 66.54 ± 11.08 | 63.72 ± 8.98 |
| 18 | Reactor I | 3.23 ± 1.33 | 2.16 ± 0.64 |
| 18 | Reactor II | 15.13 ± 4.72 | 11.96 ± 3.02 |
| 48 | Reactor I-early stage | 2.26 ± 0.86 | 0.41 ± 0.13 |
| 48 | Reactor I-middle stage | 0.72 ± 0.20 | 0.24 ± 0.06 |
| 48 | Reactor I-late stage | 0.22 ± 0.06 | 0.11 ± 0.03 |

It can be seen from Table 8 that acid values of oils produced at the low-pressure stages are high, and do not change significantly after the vacuum treatment. Among the oils produced at the high-pressure stages, an acid value of either the oil with a high acid value at the early stage or the oil with a low acid value at the late stage is significantly reduced after the vacuum treatment, with a very significant difference. It indicates that a main factor affecting an acid value at the low-pressure stages is a free fatty acid content, and factors affecting an acid value at the high-pressure stages include a carbon dioxide content in an oil in addition to a free fatty acid content.

Quality of the Camellia oleifera Abel seed oil prepared through supercritical fractionated extraction:

The Camellia oleifera Abel seed oil prepared by the above process has a yield of 93.9%, and tested for relevant indexes according to GB11765-2018 and GB2762-2017. Results are shown in Table 9.

TABLE 9
Quality indexes of the Camellia oleifera Abel seed oil
prepared through supercritical fractionated extraction

| | | | National standard | |
|---|---|---|---|---|
| Items | | Results | requirements | Remarks |
| Conventional | Smell | Requirements | There is the | |
| indexes | | to be met | inherent smell and | |
| | | | taste of Camellia | |
| | | | oleifera Abel seed | |
| | | | oil, and there is | |
| | | | no peculiar smell. | |
| | Moisture and volatile | 0.06 ± 0.05 | ≤0.20 | |
| | contents, % | | | |
| | Insoluble impurities, % | Not detected | ≤0.20 | |
| | | (<0.01) | | |
| Chemical | Acid value, mg KOH/g | 0.23 ± 0.14 | 2.0 | GB/T 11765-2018 |
| indexes | | | | Camellia oleifera Abel |
| | Peroxide value, g/100 g | 0.05 ± 0.02 | 0.25 | seed oil: standard for |
| | | | | grade 1 pressed oil |
| | Phospholipids, mg/g | Not detected | — | |
| | | (<1.0) | | |
| Plasticizer, | Di-n-butyl phthalate (DBP) | Not detected | 0.3 | “Letter of the Ministry |
| mg/kg | | (<0.1) | | of Public Health on |
| | Bis(2-ethyl)hexyl | Not detected | 1.5 | Notification of |
| | phthalate (DEHP) | (<0.5) | | Maximum Residues of |
| | Dinonyl phthalate (DNP) | Not detected | 9.0 | Phthalate Substances |
| | | (<0.5) | | in Foods and Food |
| | Diisononyl phthalate (DINP) | Not detected | 1.5 | Additives (Supervision |
| | | (<0.5) | | Letter of the General |
| | | | | Office of the National |
| | | | | Health Commission of |
| | | | | the People's Republic |
| | | | | of China [2011] No. 551) |
| Fungal toxins | Aflatoxin B1, μg/kg | Not detected | 10.0 | GB2761-2017 Limits of |
| | | (<1.0) | | fungal toxins in food |
| Polycyclic | Benzo(α)pyrene, μg/kg | Not detected | 10.0 | GB2762-2017 Limits of |
| aromatic | | (<1.0) | | contaminants in food |
| hydrocarbons | | | | |

It can be seen from the data in Table 9 that a quality of the Camellia oleifera Abel seed oil prepared through supercritical fractionated extraction can fully meet the food safety requirement of the national standard and can be directly marketed.

The content not described in detail in the description belongs to the prior art well known to those skilled in the art.

Although the present disclosure has been disclosed as above in the examples, it is not intended to limit the protection scope of the present disclosure. Any variations and modifications made by those skilled in the art without departing from the spirit and scope of the present disclosure shall fall within the protection scope of the present disclosure.

What is claimed is:

1. A method for a fractionated extraction of a woody edible oil with supercritical carbon dioxide, wherein the method adopts a Camellia oleifera Abel seed as a raw material, and comprises the following steps:
(1) oven-drying the raw material at 80° C. to 100° C. until a moisture content is 2% to 5% to obtain a dried raw material;
(2) shelling the dried raw material and crushing to a particle size of 50 mesh to obtain a crushed raw material;
(3) adding the crushed raw material to a supercritical carbon dioxide extraction device, setting a pressure of a first separation reactor to 10 MPa, a pressure of a second separation reactor to 6 MPa, a pressure of an extraction reactor to 12 MPa, and a temperature of the extraction reactor to 40° C. to 50° C., and conducting a first extraction for 1.5 h; and collecting a first isolate separately;
(4) changing the pressure of the extraction reactor to 18 MPa, conducting a second extraction for 1.0 h, and collecting a second isolate separately;
(5) changing the pressure of the extraction reactor to 48 MPa, conducting a third extraction for 4 h, and collecting a third isolate separately; and
(6) subjecting an oil extract produced in the first separation reactor in the step (5) to a vacuum carbon dioxide removal and water removal for 0.5 h to 1.0 h at 45° C. to 50° C., a stirring speed of 40 r/min to 60 r/min, and a vacuum degree of higher than −98 kPa to obtain a refined Camellia oleifera Abel seed oil.

2. The method for the fractionated extraction of the woody edible oil with the supercritical carbon dioxide according to claim 1, wherein in the step (1), the oven-drying is conducted at 90° C., and the moisture content is 2% to 3%.

3. The method for the fractionated extraction of the woody edible oil with the supercritical carbon dioxide according to claim 1, wherein in the step (3), the first extraction is conducted at 45° C.

4. The method for the fractionated extraction of the woody edible oil with the supercritical carbon dioxide according to claim 1, wherein in the step (5), after the third extraction is completed, the oil extract produced in the first separation reactor is discharged when the pressure of the first separation reactor drops to 4 MPa or less.

5. A method for a fractionated extraction of a woody edible oil with supercritical carbon dioxide, wherein the method adopts a Torreya grandis seed as a raw material, and comprises the following steps:
(1) subjecting the raw material to husking and then vacuum oven-drying at 50° C. to 80° C. until a moisture content is 2% to 5% to obtain a dried raw material;
(2) shelling the dried raw material, removing an inner seed coat with an inner seed coat removal rate of 80% to 95%, and crushing to a particle size of 50 mesh to obtain a crushed raw material;
(3) adding the crushed raw material to a supercritical carbon dioxide extraction device, setting a pressure of a first separation reactor to 8 MPa, a pressure of a second separation reactor to 5 MPa, a pressure of an extraction reactor to 8 MPa, and a temperature of the extraction reactor to 40° C. to 50° C., and conducting a first extraction for 1.0 h; and collecting a first isolate separately;
(4) changing the pressure of the extraction reactor to 16 MPa to 18 MPa, and conducting a second extraction for 1.0 h, wherein the pressure of the first separation reactor is 10 MPa and the pressure of the second separation reactor is 6 MPa; and collecting a second isolate separately;
(5) changing the pressure of the extraction reactor to 45 MPa, and conducting a third extraction for 4 h, wherein the pressure of the first separation reactor is 10 MPa and the pressure of the second separation reactor is 6 MPa; and collecting a third isolate separately;
(6) injecting an oil extract produced in the first separation reactor in the step (5) into a low-temperature chamber at −100° C. to produce 0.1 mm to 2 mm solid oil droplets, and freezing for 1 h to obtain frozen Torreya grandis seed oil droplets; and
(7) transferring the frozen Torreya grandis seed oil droplets obtained in the step (6) to a continuous freeze dryer, and conducting a water removal and a carbon dioxide removal for 1.5 h to 3.0 h at −55° C. and a vacuum degree of −99.5 kPa to obtain a refined Torreya grandis seed oil.

6. The method for the fractionated extraction of the woody edible oil with the supercritical carbon dioxide according to claim 5, wherein in the step (1), the vacuum oven-drying is conducted at 60° C. and a vacuum degree of −95 kPa until the moisture content is 2% to 3%.

7. The method for the fractionated extraction of the woody edible oil with the supercritical carbon dioxide according to claim 5, wherein in the step (2), the inner seed coat removal rate is 90%.

8. The method for the fractionated extraction of the woody edible oil with the supercritical carbon dioxide according to claim 5, wherein in the step (3), the first extraction is conducted at 42° C.

9. The method for the fractionated extraction of the woody edible oil with the supercritical carbon dioxide according to claim 5, wherein in the step (5), after the third extraction is completed, the oil extract produced in the first separation reactor is discharged when the pressure of the first separation reactor drops to 4 MPa or less.
